(19) United States
(12) Patent Application Publication
(10) Pub. No.: US 2012/0327660 A1
(43) Pub. Date: Dec. 27, 2012

(54) Lamp Capable of Storing Energy

(76) Inventor: Wen-Tsung LIN, New Taipei City (TW)

(21) Appl. No.: 13/169,053

(22) Filed: Jun. 27, 2011

(51) Int. Cl. F21V 33/00

(52) U.S. Cl. 362/253

(57) ABSTRACT

A lamp capable of storing energy comprises at least one light emitting unit, at least one solar power device, and a control unit. The solar power device is mounted adjacent to the light emitting unit. The control unit is electrically connected with the solar power device, the light emitting unit, and an electrical storage unit for storing electrical energy from the solar power device.

### (a) TECHNICAL FIELD OF THE INVENTION

The present invention relates to a lamp capable of storing energy and, more particularly, to a lamp that can collect the scattering light beams thereof and convert them into electrical energy to be stored for a future use.

### (b) DESCRIPTION OF THE PRIOR ART

In recent years, due to nuclear disaster and abnormal climate change, the world has suffered a huge loss of life and property. Also, natural resources were gradually reduced. Therefore, every country was forced to actively think about environmental protection, energy conservation, and carbon emission reduction, which are important for the future of mankind. Due to environmental awareness, green energy began to be taken seriously, so that the advantages of solar energy were gradually revealed.

Conventional lamps usually generate a lot of heat and emit light inefficiently due to some light beams being scattered and unavailable for illuminating a target. To mitigate the problem, the applicant has contrived a lamp that can collect the scattering light beams thereof to be stored in an electrical storage unit for a future use.

### SUMMARY OF THE INVENTION

The primary object of the present invention is to provide a lamp that can collect the scattering light beams thereof and convert them into electrical energy to be stored for a future use.

The secondary object of the present invention is to enhance the utilization of green energy and reducing energy consumption.

To achieve the objects of the present invention, a lamp capable of storing energy is provided, which comprises at least one light emitting unit, at least one solar power device, and a control unit; wherein the solar power device is mounted adjacent to the light emitting unit; and wherein the control unit is electrically connected with the solar power device, the light emitting unit, and an electrical storage unit for storing electrical energy from the solar power device.

Preferably, the lamp further comprises a second light emitting unit that is electrically connected with the control unit via a sensor.

Preferably, the lamp further comprises a switch that is electrically connected with the control unit.

Preferably, the light emitting light can be a gas-discharge lamp, a light-emitting diode, or an organic light-emitting semiconductor.

Preferably, the electrical storage unit can be a gold capacitor, a secondary or rechargeable battery, or a battery.

Preferably, the second light emitting light can be a light-emitting diode, or an organic light-emitting semiconductor.

Preferably, the sensor can be a photo-resistor, a light-detecting element, or an infrared detector.

Preferably, the solar power device can be mounted on a cover or a base of the lamp.

Preferably, the solar power device can be constructed of solar wafer, solar panel or solar paint.

Through the technical means of the present invention, when the light emitting unit is energized, the solar power device can receive the light beams scattering therefrom and convert them into electrical energy to be stored in the electrical storage unit. When the main power is disconnected, the electrical storage unit can supply power for the light emitting unit. Furthermore, under this condition, when the sensor detects that the light is dim, the second light emitting unit can be turned on by the control unit to increase the brightness. Therefore, the lamp can collect the light beams scattering therefrom and convert them into electrical energy to be stored in the electrical storage unit for supplying the light emitting units with electrical energy at a later time to achieve a reuse of the light beams.

Other objects, advantages, and novel features of the present invention will become more apparent from the following detailed description when taken in conjunction with the accompanying drawings.

### BRIEF DESCRIPTION OF THE DRAWINGS

FIG. 1 is a 3-dimensional view of an embodiment of the present invention.

FIG. 2 is an exploded view of the embodiment of the present invention.

FIG. 3 is a partially exploded view of the embodiment of the present invention.

FIG. 4 is another partially exploded view of the embodiment of the present invention.

FIG. 5 is a 3-dimensional view of another embodiment of the present invention.

### DETAILED DESCRIPTION OF THE PREFERRED EMBODIMENTS

To allow the features, advantages, and the effects of the present invention to be understood more easily, a description with reference to the accompanying drawing will be detailed in the following.

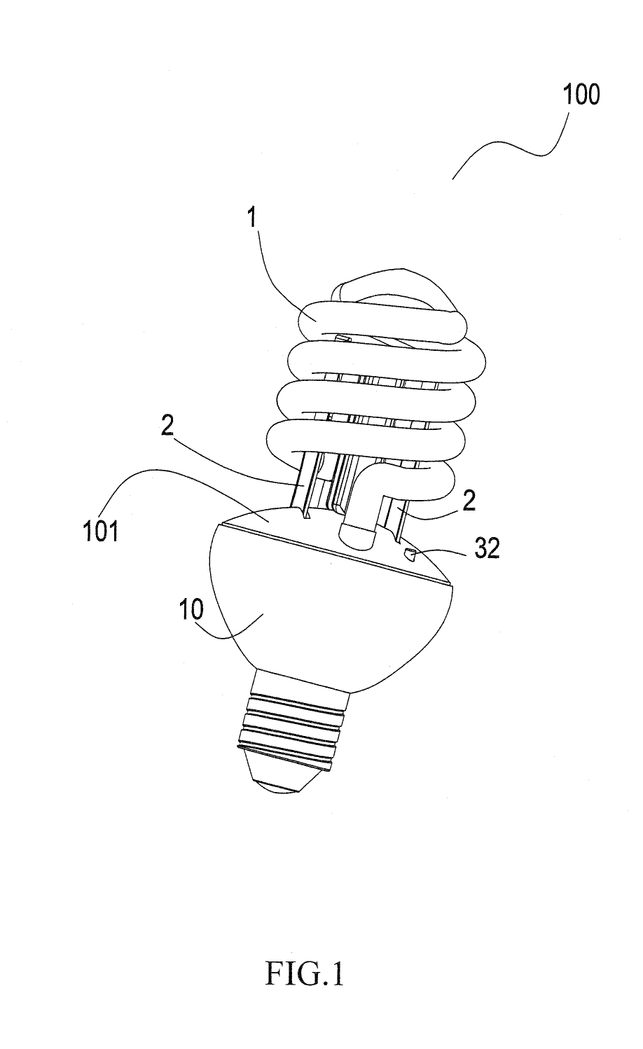

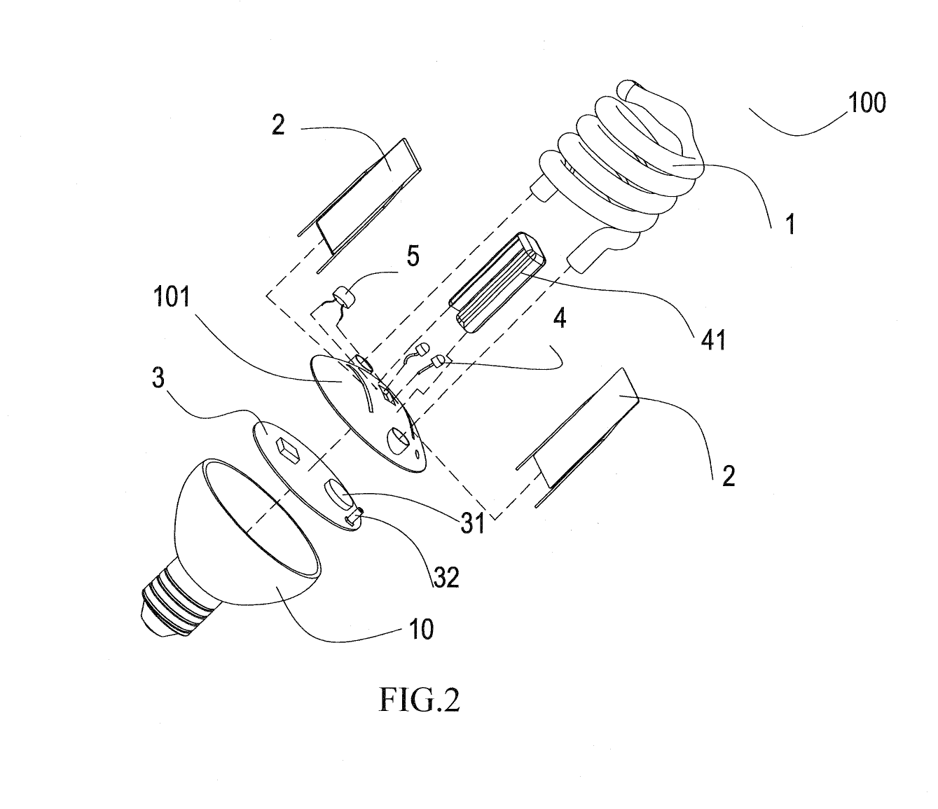

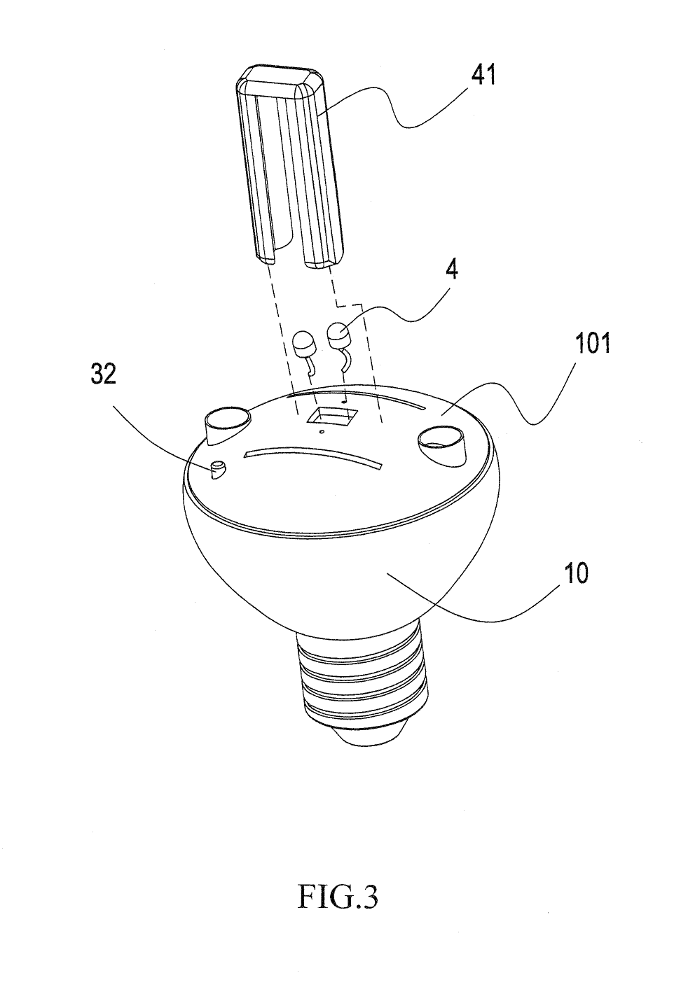

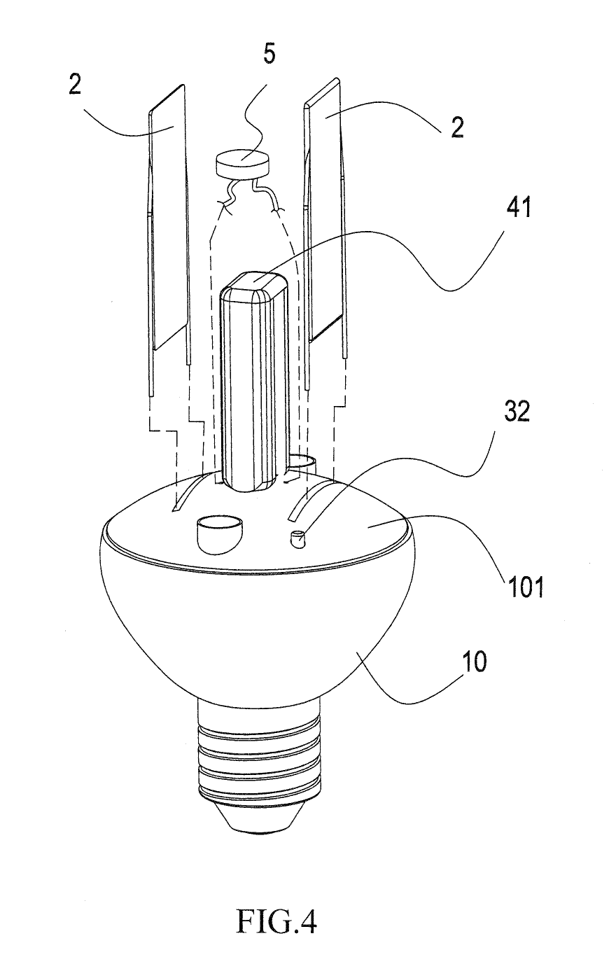

Referring to FIGS. 1-4, a lamp capable of storing energy according to the present invention is indicated at reference numeral 100, which generally comprises a light emitting unit 1, two solar power devices 2, a control unit 3, an electrical storage unit 31 for storing electrical energy from the solar power devices 2, and a switch 32. The light emitting unit 1 can be a gas-discharge lamp, a light-emitting diode, or an organic light-emitting semiconductor. In this embodiment, a spiral gas-discharge lamp is employed. The solar power devices 2 can be constructed of solar wafer, solar panel or solar paint and can be mounted on a cover or a base of the lamp. In this embodiment, the solar power devices 2 are constructed of solar wafer and are mounted on the base 10. The control unit 3, which electrically connects with the electrical storage unit 3 land the switch 32, is secured between the base 10 and the cover 101 having a plurality of through holes. The electrical storage unit 31 can be a gold capacitor, a secondary or rechargeable battery or a battery. In this embodiment, a rechargeable battery is employed.

The solar power devices 2 are mounted adjacent to the light emitting unit 1. The solar power devices 2 and the light emitting unit 1 are electrically connected to the control unit 3. Furthermore, a second light emitting unit 4 is electrically connected to the control unit 3. The second light emitting unit 4 is covered with a lamp shade 41 and mounted between the two solar power devices 2. A sensor 5, being placed over the lamp shade 41, is electrically connected to the control unit 3. The second light emitting unit 4 can be a light-emitting diode or an organic light-emitting semiconductor. In this embodiment, the second light emitting unit 4 is a light-emitting diode. The sensor 5 can be a photo-resistor, a light-detecting element, or an infrared detector. In this embodiment, the sensor 5 is a photo-resistor.

The above-mentioned components are fixedly mounted within an inner space spiraled around by the spiral gas-discharge lamp 1 via the through holes of the cover 101.

When the light emitting unit 1 is energized to emit light for a target, the solar power devices 2 can also receive light as well, thereby converting light into electrical energy to be stored in the electrical storage unit 31. When the main power supply is disconnected, the electrical storage unit 31 can supply electrical power for the light emitting unit 1. Furthermore, under this condition, when the sensor 5 detects that the light is dim, the second light emitting unit 4 can be turned on by the control unit 3 to increase the brightness. Furthermore, when the electrical storage unit 31 runs out of electrical energy therein, the control unit 3 can switch power supply from the electrical storage unit 31 to an external power supply automatically. When the second light emitting unit 4 is not required, it can be turned off by the switch 32 being electrically connected with the control unit 3.

The switch 32 can also be used to turn on the light emitting unit 1 or the second light emitting unit 4 according to the preference of a user.

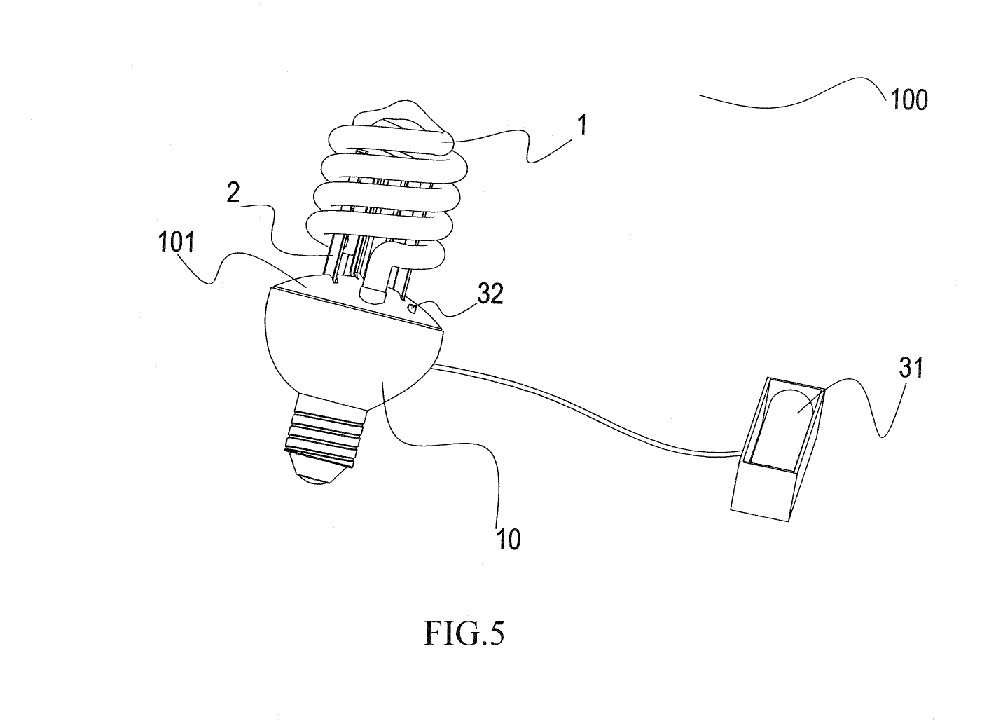

As shown in FIG. 5, the electrical storage unit 31 can be installed outside of the lamp for ease of replacing an exhausted secondary or rechargeable battery.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. A lamp capable of storing energy, comprising:
at least one light emitting unit;
at least one solar power device being mounted adjacent to said light emitting unit; and
a control unit being electrically connected with said solar power device, said light emitting unit, and an electrical storage unit for storing electrical energy from said solar power device.

2. The lamp of claim 1, further comprising a second light emitting unit that is electrically connected with said control unit via a sensor.

3. The lamp of claim 2, further comprising a switch that is electrically connected with said control unit.

4. The lamp of claim 1, wherein said solar power device can be constructed of solar wafer, solar panel or solar paint.

5. The lamp of claim 1, wherein said light emitting light can be a gas-discharge lamp, a light-emitting diode, or an organic light-emitting semiconductor.

6. The lamp of claim 1, wherein said electrical storage unit can be a gold capacitor, a secondary or rechargeable battery or a battery.

7. The lamp of claim 2, wherein said second light emitting unit can be a light-emitting diode or an organic light-emitting semiconductor.

8. The lamp of claim 2, wherein said sensor can be a photo-resistor, a light-detecting element, or an infrared detector.

9. The lamp of claim 1, wherein said solar power device can be mounted on a cover or a base.

10. The lamp of claim 1, wherein when said electrical storage unit runs out of electrical energy therein, said control unit can switch power supply from said electrical storage unit to an external power supply automatically, or said control unit can switch the lighting pattern of the lamp manually according to the custom of a user.
